(19) United States
(12) Patent Application Publication
(10) Pub. No.: US 2026/0056021 A1
(43) Pub. Date: Feb. 26, 2026

(54) CONTROL SYSTEM

(71) Applicant: TOYOTA JIDOSHA KABUSHIKI KAISHA, Toyota-shi (JP)

(72) Inventor: Hiroki FURUTA, Susono-shi (JP)

(73) Assignee: TOYOTA JIDOSHA KABUSHIKI KAISHA, Toyota-shi (JP)

(21) Appl. No.: 19/303,290

(22) Filed: Aug. 18, 2025

(30) Foreign Application Priority Data
Aug. 20, 2024 (JP) 2024-139069

(51) Int. Cl. G01C 21/34; B60W 40/08; B60W 40/10; B60W 60/00; G01C 21/36

(52) U.S. Cl. CPC G01C 21/3461; B60W 40/08; B60W 40/10; B60W 60/0013; B60W 60/0021; G01C 21/3658; B60W 2040/0881; B60W 2556/40

(57) ABSTRACT

A control system includes a sensor that acquires a value relevant to vertical motion of a wheel of a vehicle and controls an objective vehicle that performs autonomous driving. The control system includes one or more processors, and a storage device that stores map data in which a vertical motion parameter relevant to the vertical motion is associated with a position on a map. The one or more processors determines whether a passenger rides in the objective vehicle, more preferentially selects a first route than a second route as a traveling route of the objective vehicle, in a case where no passenger rides in the objective vehicle, the map data of the first route being less than the map data of the second route, and acquires the value relevant to the vertical motion from the sensor, during traveling of the objective vehicle.

### CROSS-REFERENCE TO RELATED APPLICATION

This application claims priority to Japanese Patent Application No. 2024-139069 filed on Aug. 20, 2024. The disclosure of the above-identified application, including the specification, drawings, and claims, is incorporated by reference herein in its entirety.

### BACKGROUND

### 1. Technical Field

The present disclosure relates to a control system.

### 2. Description of Related Art

U.S. Patent Application Publication No. 2018/0154723 (US 2018/0154723 A1) discloses a road surface displacement map showing the correspondence relation between a road surface displacement (road surface roughness) and a position. A vibration damping control is performed by using the road surface displacement map. Specifically, the road surface displacement at a predetermined position ahead of a vehicle is previously recognized from the road surface displacement map. The control amount of an active suspension is previously calculated depending on the previously recognized road surface displacement. Then, the vibration of the vehicle is effectively restrained by controlling the active suspension at the timing when a wheel passes through the predetermined position.

### SUMMARY

In a preview control for reducing the vibration of a sprung structure of a vehicle, it is possible that map data in which a road surface displacement relevant value relevant to the displacement of a road surface in the vertical direction is mapped while being linked with the position is used for controlling an actuator that controls the suspension stroke of a controlled objective wheel. The map data can be created or updated based on a value that is to be acquired from a sensor equipped in the vehicle, at the time of the traveling of the vehicle.

Suppose that the value is acquired from the sensor and the map data is updated at the time of the traveling of an autonomous driving vehicle. In the case of a plurality of candidate routes, the traveling on a route for which the map data has not yet been acquired, if possible, is more efficient, from the standpoint of the collection of the data. However, on the route for which the map data has not been acquired, there is a possibility that the preview control cannot be accurately performed, and there is a possibility that the ride quality for an occupant decreases. Therefore, the data is efficiently collected such that the ride quality for the occupant is not impaired.

An aspect of the present disclosure relates to a control system including a sensor configured to acquire a value relevant to vertical motion of a wheel of a vehicle, the control system controlling an objective vehicle that performs autonomous driving. The control system includes one or more processors, and a storage device configured to store map data in which a vertical motion parameter relevant to the vertical motion is associated with a position on a map. The one or more processors are configured to determine whether a passenger rides in the objective vehicle, more preferentially select a first route than a second route, as a traveling route of the objective vehicle, in a case the passenger does not ride in the objective vehicle, the map data of the first route being less than the map data of the second route, and acquire the value relevant to the vertical motion from the sensor, while the objective vehicle is traveling.

With the present disclosure, when no passenger rides in the objective vehicle, the route for which the amount of the map data is small is more preferentially selected than the route for which the amount of the map data is large, as the traveling route of the objective vehicle. Thereby, it is possible to more efficiently expand the map data based on information that is to be acquired during the traveling of the objective vehicle. Further, the traveling route for which the amount of the map data is small is preferentially selected, when no passenger rides, and therefore, it is possible to prevent the decrease in the ride quality for the passenger and the impairment in comfortableness.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a schematic diagram showing an exemplary configuration of a vehicle according to an embodiment;

FIG. 2 is a conceptual diagram showing an exemplary configuration of a suspension according to the embodiment;

FIG. 3 is a flowchart showing an example of an unsprung displacement calculation process according to the embodiment;

FIG. 4 is a block diagram showing an exemplary configuration of a vehicle control system according to the embodiment;

FIG. 5 is a block diagram showing an example of driving environment information according to the embodiment;

FIG. 6 is a block diagram showing an exemplary configuration of a map management system according to the embodiment;

FIG. 7 is a conceptual diagram for describing an unsprung displacement map according to the embodiment;

FIG. 8 is a flowchart schematically showing a map generation-update process according to the embodiment;

FIG. 9 is a conceptual diagram for describing a preview control using the unsprung displacement map according to the embodiment;

FIG. 10 is a flowchart showing the preview control using the unsprung displacement map according to the embodiment;

FIG. 11 is a flowchart showing an example of a processing flow about the selection of a traveling route by a control device of the vehicle control system;

FIG. 12 is a conceptual diagram showing a specific example of the selection of the traveling route by the control device of the vehicle control system according to the embodiment; and

FIG. 13 is a flowchart showing an example of a processing flow about the selection of the traveling route by the control device of the vehicle control system.

### DETAILED DESCRIPTION OF EMBODIMENTS

An embodiment of the present disclosure will be described below with reference to the accompanying drawing. In the figures, identical or corresponding constituents are denoted by identical reference characters, and descriptions thereof are simplified or omitted.

### 1 Suspension and Vertical Motion Parameter

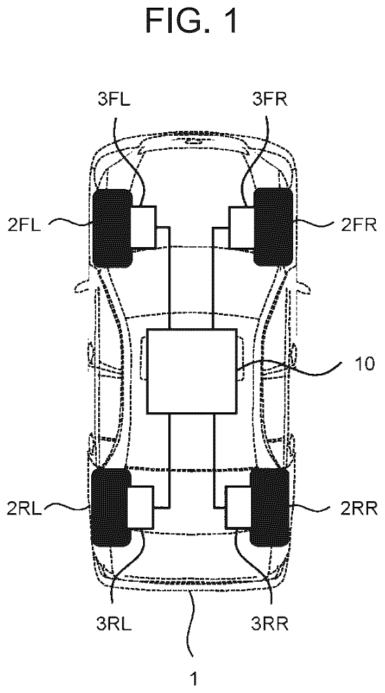

FIG. 1 is a schematic diagram showing an exemplary configuration of a vehicle 1 (objective vehicle) according to the embodiment. The vehicle 1 is an autonomous driving vehicle that can perform autonomous driving. The vehicle 1 includes wheels 2 and suspensions 3. The wheels 2 include a left front wheel 2FL, a right front wheel 2FR, a left rear wheel 2RL, and a right rear wheel 2RR. Suspensions 3FL, 3FR, 3RL, 3RR are provided for the left front wheel 2FL, the right front wheel 2FR, the left rear wheel 2RL, and the right rear wheel 2RR, respectively. In the following description, when it is not particularly necessary to make distinction, each wheel is referred to as a wheel 2, and each suspension is referred to as a suspension 3.

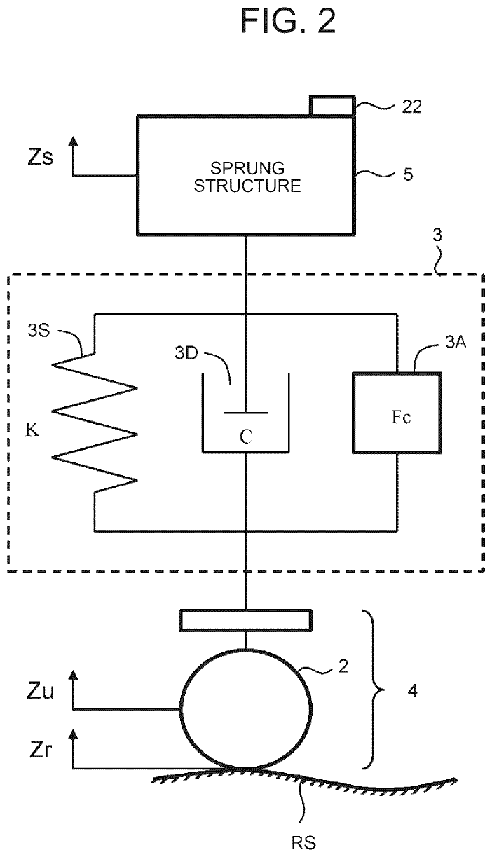

FIG. 2 is a conceptual diagram showing an exemplary configuration of the suspension 3. The suspension 3 is provided so as to couple an unsprung structure 4 and sprung structure 5 of the vehicle 1. The unsprung structure 4 includes the wheel 2. The suspension 3 includes a spring 3S, a damper (shock absorber) 3D, and an actuator 3A. The spring 3S, the damper 3D, and the actuator 3A are provided in parallel between the unsprung structure 4 and the sprung structure 5. The spring constant of the spring 3S is K. The attenuation coefficient of the damper 3D is C. The damping force of the damper 3D may be variable. The actuator 3A applies a control force Fc in the vertical direction between the unsprung structure 4 and the sprung structure 5.

Terms will be defined. A “road surface displacement Zr” is the displacement of a road surface RS in the vertical direction. An “unsprung displacement Zu” is the displacement of the unsprung structure 4 in the vertical direction. A “sprung displacement Zs” is the displacement of the sprung structure 5 in the vertical direction. An “unsprung velocity Zu′” is the velocity of the unsprung structure 4 in the vertical direction. A “sprung velocity Zs′” is the velocity of the sprung structure 5 in the vertical direction. An “unsprung acceleration Zu″” is the acceleration of the unsprung structure 4 in the vertical direction. A “sprung acceleration Zs″” is the acceleration of the sprung structure 5 in the vertical direction. The sign of each parameter is positive in the case of the upward direction, and is negative in the case of the downward direction.

The wheel 2 moves on the road surface RS. In the following description, a parameter relevant to the vertical motion of the wheel 2 is referred to as a “vertical motion parameter”. Examples of the vertical motion parameter include the above road surface displacement Zr, unsprung displacement Zu, unsprung velocity Zu′, unsprung acceleration Zu″, sprung displacement Zs, sprung velocity Zs′, and sprung acceleration Zs″. It can be said that the vertical motion parameter is a “road surface displacement relevant parameter” relevant to the road surface displacement Zr.

As an example, in the following description, a case where the vertical motion parameter is the unsprung displacement Zu will be discussed. In the case of generalization, the “unsprung displacement” in the following description is replaced with the “vertical motion parameter”.

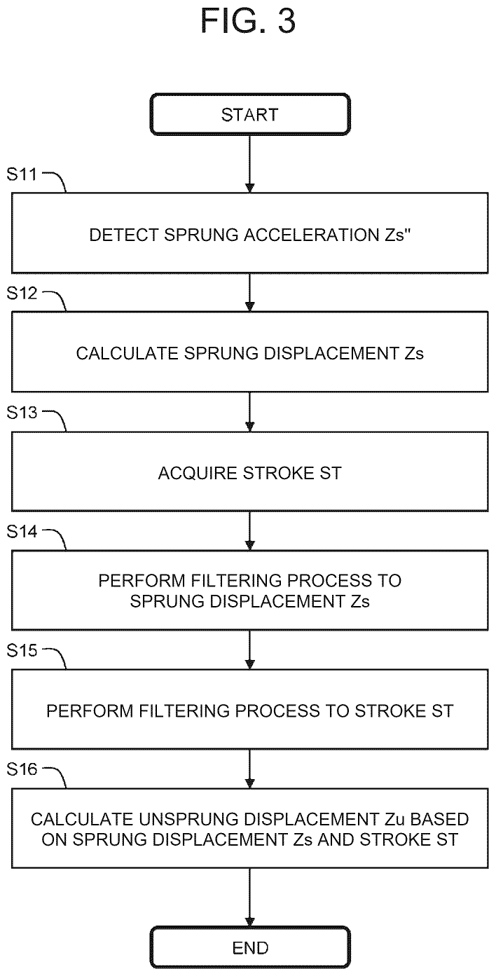

FIG. 3 is a flowchart showing an example of an unsprung displacement calculation process.

In step S11, the sprung acceleration Zs″ is detected by a sprung acceleration sensor 22 that is installed at the sprung structure 5. In step S12, the sprung acceleration Zs″ is integrated twice, and thereby, the sprung displacement Zs is calculated.

In step S13, a stroke ST (=Zs−Zu) that is a relative displacement between the sprung structure 5 and the unsprung structure 4 is acquired. For example, the stroke ST is detected by a stroke sensor that is installed at the suspension 3. As another example, the stroke ST may be estimated based on the sprung acceleration Zs″, by an observer that is configured based on a single-wheel two-degree-of-freedom model.

In step S14, a filtering process is performed to the time-series data of the sprung displacement Zs, for restraining the influence of sensor drift or the like. Similarly, in step S15, the filtering process is performed to the time-series data of the stroke ST. For example, the filter is a bandpass filter through which signal components in a particular frequency band pass. The particular frequency band may be set so as to include a sprung resonance frequency of the vehicle 1. For example, the particular frequency band is 0.3 Hz to 10 Hz.

In step S16, the difference between the sprung displacement Zs and the stroke ST is calculated as the unsprung displacement Zu.

Instead of step S14 and step S15, the filtering process may be performed to the time-series data of the unsprung displacement Zu that is calculated in step S16.

Furthermore, as another example, the unsprung acceleration Zu″ may be detected by an unsprung acceleration sensor, and the unsprung displacement Zu may be calculated from the unsprung acceleration Zu″.

### 2 Vehicle Control System

### 2.1 Exemplary Configuration

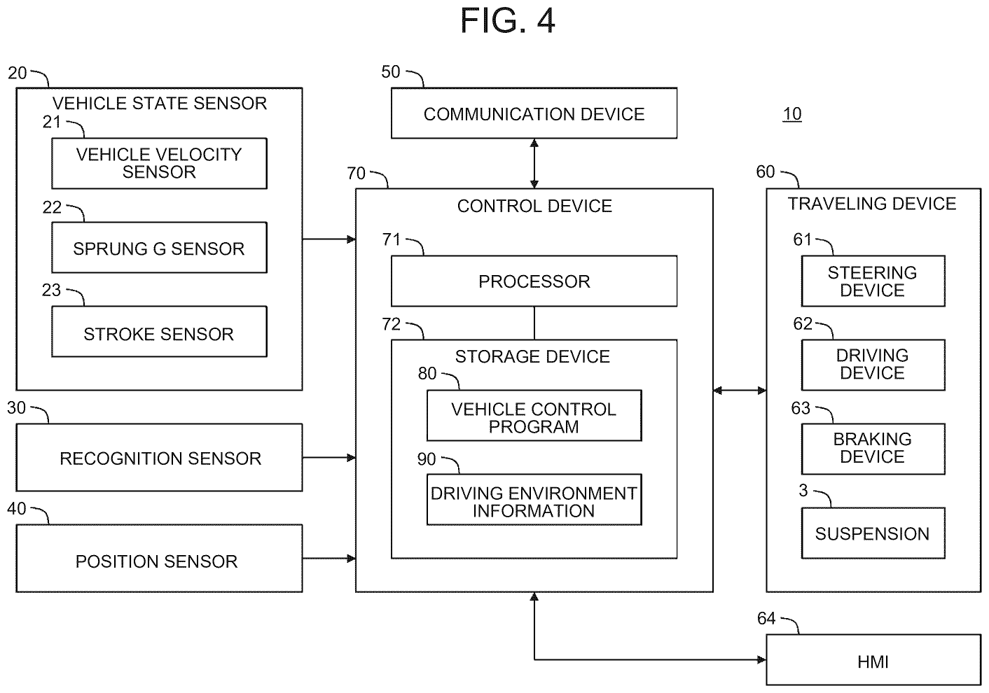

FIG. 4 is a block diagram showing an exemplary configuration of a vehicle control system 10 according to the embodiment. The vehicle control system 10 is equipped in the vehicle 1, and controls the vehicle 1. The control of the vehicle 1 that is performed by the vehicle control system 10 includes an autonomous driving control of the vehicle 1. The vehicle control system 10 includes a vehicle state sensor 20, a recognition sensor 30, a position sensor 40, a communication device 50, a traveling device 60, an HMI 64, and a control device 70.

The vehicle state sensor 20 detects the state of the vehicle 1. The vehicle state sensor 20 includes a vehicle velocity sensor (wheel speed sensor) 21 that detects a vehicle velocity V of the vehicle 1, the sprung acceleration sensor 22 that detects the sprung acceleration Zs″, and others. The vehicle state sensor 20 may include a stroke sensor 23 that detects the stroke ST. The vehicle state sensor 20 may include an unsprung acceleration sensor. In addition, the vehicle state sensor 20 includes a lateral acceleration sensor, a yaw rate sensor, a rudder angle sensor, and others.

The recognition sensor 30 recognizes (detects) the situation of the periphery of the vehicle 1. Examples of the recognition sensor 30 include a camera, a laser imaging detection and ranging (LIDAR), and a radar.

The position sensor 40 detects the position and orientation of the vehicle 1. For example, the position sensor 40 includes a global navigation satellite system (GNSS).

The communication device 50 communicates with the exterior of the vehicle 1.

The traveling device 60 includes a steering device 61, a driving device 62, a braking device 63, and the suspension 3 (see FIG. 2). The steering device 61 turns the wheel 2. For example, the steering device 61 includes a power steering (EPS: Electric Power Steering) device. The driving device 62 is a dynamic power source that generates driving power. Examples of the driving device 62 include an engine, an electric motor, and an in-wheel motor. The braking device 63 generates braking power.

The HMI 64 presents a variety of information to a user by displaying or sound, and accepts a variety of inputs from the user. Typically, the user of the vehicle 1 is an occupant or driver of the vehicle 1. The HMI 64 is constituted by a display (e.g.; a multi-information display, a meter display, and a head-up display), a switch (e.g.; a steering switch and a door switch), a touch pad, a speakerphone, a touch screen, a microphone, and others.

The control device 70 is a computer that controls the vehicle 1. The control device 70 includes one or more processors 71 (referred to as merely a processor 71, hereinafter) and one or more storage devices 72 (referred to as merely a storage device 72, hereinafter). The control device 70 may include one or more electronic control units (ECUs).

The processor 71 executes various processes. For example, the processor 71 is constituted by a general-purpose processor, an application specific processor, a central processing unit (CPU), a graphics processing unit (GPU), an application specific integrated circuit (ASIC), a field-programmable gate array (FPGA), an integrated circuit, a conventional circuit, or one or more combinations of them. The processor 71 can be called a circuitry or a processing circuitry. The circuitry is hardware that includes programs for realizing functions of the control device 70, or hardware that executes functions of the control device 70.

The storage device 72 stores a variety of information necessary for the processor 71 to execute processes. For example, the storage device 72 is constituted by a recording medium such as a random-access memory (RAM), a read-only memory (ROM), a solid-state drive (SSD), and a hard disk drive (HDD).

The storage device 72 stores a vehicle control program 80. The vehicle control program 80 is a computer program for controlling the vehicle 1, and is executed by the processor 71. The vehicle control program 80 is constituted by an instruction set in which processes to be executed by the processor 71 are written. The vehicle control program 80 is recorded in a computer-readable recording medium. The processor 71 executes the vehicle control program 80, such that functions of the control device 70 are realized.

### 2.2 Driving Environment Information

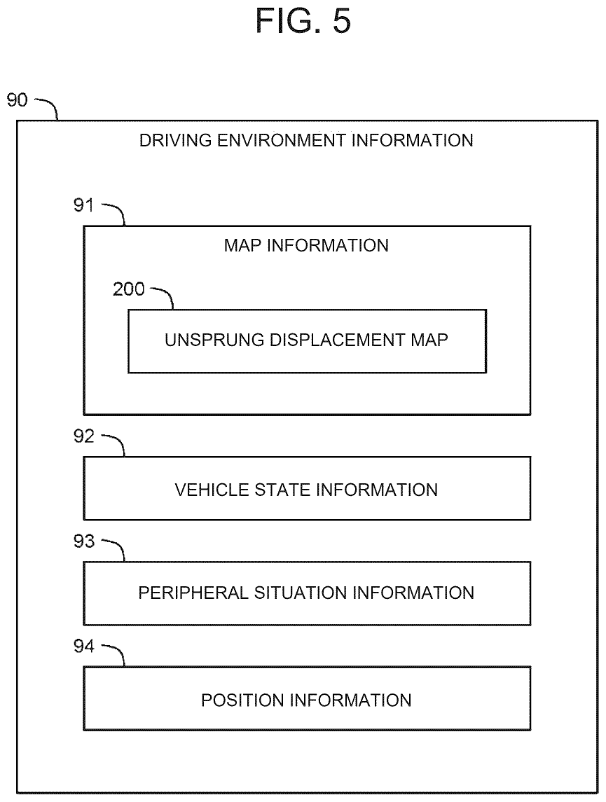

FIG. 5 is a block diagram showing an example of driving environment information 90 that indicates the driving environment of the vehicle 1. The driving environment information 90 is stored in the storage device 72. The driving environment information 90 includes map information 91, a vehicle state information 92, peripheral situation information 93, and position information 94.

The map information 91 includes a general navigation map. The map information 91 may indicate lane disposition, road form, and others. The map information 91 may include position information about white lines, traffic lights, signs, landmarks, and others. The map information 91 is obtained from a map database. The map database may be equipped in the vehicle 1, or may be stored in a management server in the exterior. In the case of the latter, the control device 70 communicates with the management server, and acquires the map information 91 that is needed.

The map information 91 further includes an “unsprung displacement map 200”. Details of the unsprung displacement map 200 will be described later.

The vehicle state information 92 is information that indicates the state of the vehicle 1. The control device 70 acquires the vehicle state information 92 from the vehicle state sensor 20. For example, the vehicle state information 92 includes the vehicle velocity V, the sprung acceleration Zs″, the stroke ST, the lateral acceleration, the yaw rate, and the rudder angle. The vehicle velocity V may be calculated from the vehicle position that is detected by the position sensor 40. The control device 70 may calculate the unsprung displacement Zu by the technique shown in FIG. 3. In that case, the vehicle state information 92 includes also the unsprung displacement Zu that is to be calculated by the control device 70.

The peripheral situation information 93 is information that indicates the situation of the periphery of the vehicle 1. The control device 70 recognizes the situation of the periphery of the vehicle 1, using the recognition sensor 30, and acquires the peripheral situation information 93. For example, the peripheral situation information 93 includes image information that is picked up by the camera. As another example, the peripheral situation information 93 includes point cloud information that is obtained by the LIDAR.

The peripheral situation information 93 further includes “physical body information” about a physical body in the periphery of the vehicle 1. Examples of the physical body include a pedestrian, a bicycle, another vehicle (a proceeding vehicle, a parked vehicle, or the like), a road constitution (a white line, a curb, a guardrail, a wall, a center divider, a roadside structure, or the like), a sign, a pole, and an obstacle. The physical body information indicates the position and velocity of the physical body relative to the vehicle 1. For example, the image information obtained by the camera is analyzed. Thereby, the physical body can be specified, and the relative position of the physical body can be calculated. Further, the physical body may be specified and the relative position and relative velocity of the physical body can be acquired, based on the point cloud information obtained by the LIDAR.

The position information 94 is information that indicates the position and orientation (vehicle moving direction) of the vehicle 1. The control device 70 acquires the position information 94 from the measurement result of the position sensor 40 such as the GNSS. As another example, the control device 70 may acquire the position information 94 by dead reckoning. Furthermore, as another example, the control device 70 may acquire the position information 94 with high accuracy, by a well-known self-position estimation process (localization) using the physical body information and the map information 91.

### 2.3 Vehicle Traveling Control

The control device 70 executes a vehicle traveling control to control the traveling of the vehicle 1. The vehicle traveling control includes a steering control, a driving control, and a braking control. The control device 70 executes the vehicle traveling control by controlling the traveling device 60 (the steering device 61, the driving device 62, and the braking device 63). The control device 70 can perform the autonomous driving control of the vehicle 1, based on the driving environment information 90. Further, the control device 70 may perform a driving assist control to assist the driving of the vehicle 1, based on the driving environment information 90. Examples of the driving assist control include a lane keeping control and a collision avoidance control.

Furthermore, the control device 70 controls the suspension 3. Typically, the control device 70 performs a vibration damping control to restrain the vibration of the vehicle 1, by controlling the suspension 3. For example, the control device 70 controls the actuator 3A, and thereby, generates the control force Fc in the vertical direction between the unsprung structure 4 and the sprung structure 5 (see FIG. 2). As another example, the control device 70 may perform the variable control of the damping force of the damper 3D. The vibration damping control includes a “preview control” described later.

### 3 Map Management System

### 3.1 Exemplary Configuration

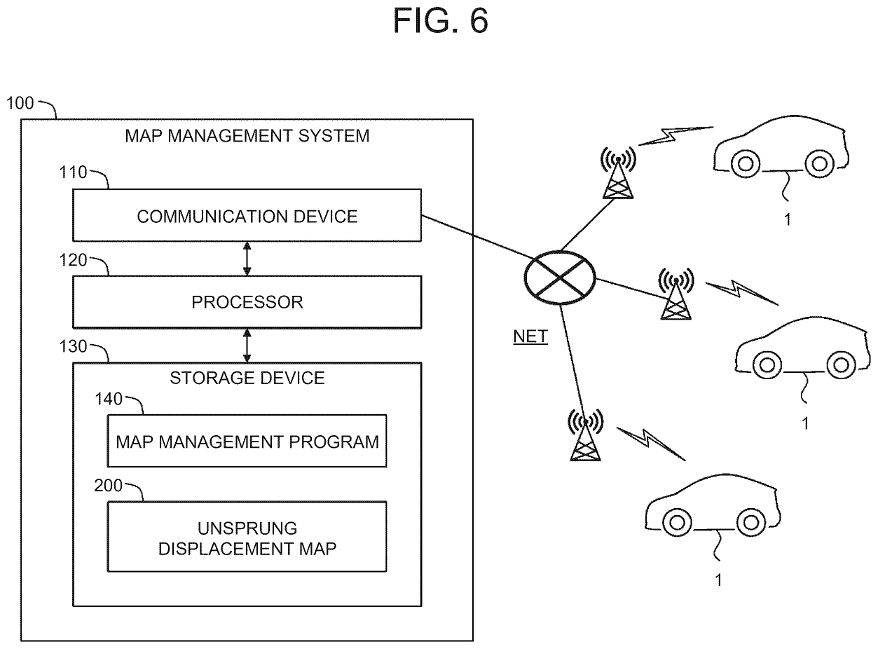

FIG. 6 is a block diagram showing an exemplary configuration of a map management system 100 according to the embodiment. The map management system 100 is a computer that manages a variety of map information. The management of the map information includes the generation, update, provision, delivery, and others of the map information. Typically, the map management system 100 is a management server on the cloud. The map management system 100 may be a distributed system in which a plurality of servers performs distributed processing.

The map management system 100 includes a communication device 110. The communication device 110 is connected to a communication network NET. For example, the communication device 110 communicates with many vehicles 1 through the communication network NET.

The map management system 100 further includes one or more processors 120 (referred to as merely a processor 120, hereinafter) and one or more storage devices 130 (referred to as merely a storage device 130, hereinafter).

The processor 120 executes various processes. For example, the processor 120 is constituted by a general-purpose processor, an application specific processor, a CPU, a GPU, an ASIC, an FPGA, an integrated circuit, a conventional circuit, or one or more combinations of them. The storage device 130 stores a variety of map information. Further, the storage device 130 stores a variety of information necessary for the processor 120 to execute processes. For example, the storage device 130 is constituted by a recording medium such as a RAM, a ROM, an SSD, and an HDD.

The storage device 130 stores a map management program 140. The map management program 140 is a computer program for map management, and is executed by the processor 120. The map management program 140 is constituted by an instruction set in which processes to be executed by the processor 120 are written. The map management program 140 is recorded in a computer-readable recording medium. The processor 120 executes the map management program 140, such that functions of the map management system 100 are realized.

The processor 120 communicates with the vehicle control system 10 of the vehicle 1 through the communication device 110. The processor 120 collects a variety of information from the vehicle control system 10, and generates and updates the map information based on the collected information. Further, the processor 120 delivers the map information to the vehicle control system 10. Further, the processor 120 provides the map information in response to a request from the vehicle control system 10.

### 3.2 Unsprung Displacement Map

The map information that is managed by the map management system 100 includes the “unsprung displacement map (vertical motion parameter map) 200”. The unsprung displacement map 200 is a map about the unsprung displacement Zu (vertical motion parameter). The unsprung displacement map 200 is stored in the storage device 130.

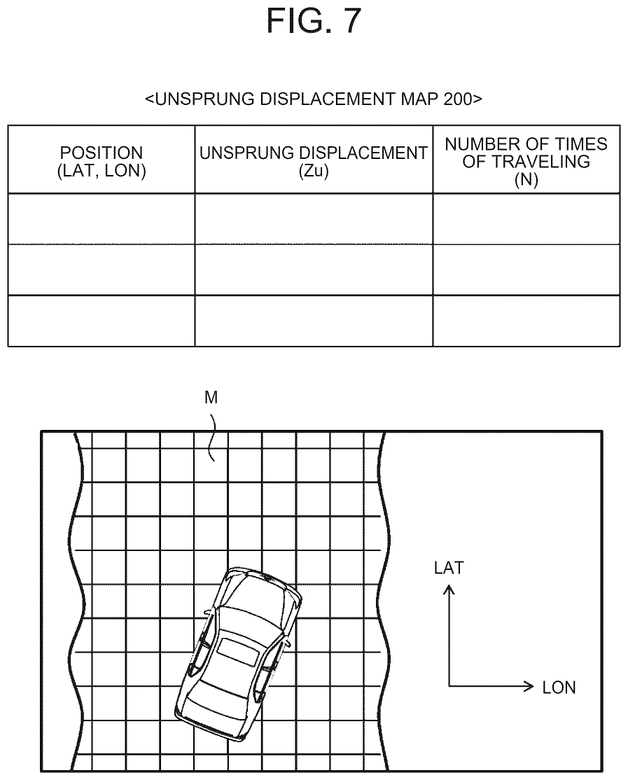

FIG. 7 is a conceptual diagram for describing the unsprung displacement map 200. For example, an absolute coordinate system on a horizontal plane is defined by a latitude direction and a longitude direction, and a position is defined by a latitude LAT and a longitude LON. In the unsprung displacement map 200, at least the unsprung displacement Zu is associated with the position (LAT, LON) on the map. In other words, the unsprung displacement map 200 expresses the unsprung displacement Zu as a function of at least the position (LAT, LON). Furthermore, in the unsprung displacement map 200, a “number N of times of traveling” may be associated with the position (LAT, LON) on the map. As described later, the unsprung displacement Zu at a certain position (LAT, LON) is evaluated based on information obtained in the vehicle 1 that actually traveled at the certain position. The number N of times of traveling at a certain position (LAT, LON) indicates the number of times that the vehicle 1 involved in the evaluation of the unsprung displacement Zu traveled at the certain position. Generally, the unsprung displacement Zu at a certain position (LAT, LON) has a higher accuracy as the number N of times of traveling at the certain position is larger. This is because the amount of data for evaluating the unsprung displacement Zu is larger as the number N of times of traveling is larger. The number N of times of traveling can be replaced with “the number N of times of evaluation” or “the number N of times of update”.

A road region may be segmented in a mesh pattern, on the horizontal plane. That is, the road region may be segmented into a plurality of unit areas M, on the horizontal plane. For example, the unit area M has a rectangular form. For example, the unit area M is a square shape in which the length of one side is 10 cm. The unsprung displacement map 200 shows the correspondence relation between the position of the unit area M and the unsprung displacement Zu. The position of the unit area M may be defined by a representative position (e.g.: a center position) in the unit area M, or may be defied by the range (a latitude range and a longitude range) of the unit area M. For example, the unsprung displacement Zu of the unit area M is the average value of unsprung displacements Zu acquired in the unit area M. The resolution of the unsprung displacement map 200 increases as the unit area M is smaller.

The unsprung displacement map 200 may be constituted by a plurality of layers stratified according to the number N of times of traveling. For example, the unsprung displacement map 200 may be constituted by a layer showing map data in which the number N of times of traveling is 0 or more and less than 10, a layer showing map data in which the number N of times of traveling is 10 or more and less than 30, and a layer showing map data in which the number N of times of traveling is 30 or more. By constituting the unsprung displacement map 200 by a plurality of layers in this way, it is possible to distinguish map data in which the accuracy of the unsprung displacement Zu is different.

Further, it is known that the unsprung displacement Zu is different depending on the velocity of the vehicle 1. Therefore, the unsprung displacement map 200 may be constituted by a plurality of layers stratified according to the velocity range of the vehicle 1. For example, the unsprung displacement map 200 may be constituted by a layer showing map data for a low velocity range of 0 km/h or higher and lower than 30 km/h, a layer showing map data for a middle velocity range of 30 km/h or higher and lower than 60 km/h, and a layer showing map data for a high velocity range of 60 km/h or higher. By constituting the unsprung displacement map 200 by a plurality of layers in this way, it is possible to manage the unsprung displacement Zu with higher accuracy depending on the velocity of the vehicle 1 for each of the layers.

### 3.3 Map Generation-Update Process

The processor 120 collects information from many vehicles 1 through the communication device 110. Then, the processor 120 generates and updates the unsprung displacement map 200 based on the information collected from the many vehicles 1. An example of the map generation-update process will be described below in more detail.

The position on the unsprung displacement map 200 is a position through which the wheel 2 has passed. The position of each wheel 2 is calculated based on the position information 94. Specifically, the relative position relation between a reference point of the vehicle position in the vehicle 1 and each wheel 2 is known information. The position of each wheel 2 can be calculated based on the relative position relation and the vehicle position shown by the position information 94.

The unsprung displacement Zu is calculated by the technique shown in FIG. 3. That is, the sprung displacement Zs and the stroke ST are obtained using the vehicle state sensor 20 equipped in the vehicle 1. For convenience sake, the sprung displacement Zs and the stroke ST are referred to as “sensor-based information”. The unsprung displacement Zu is calculated based on the sensor-based information.

For example, during the traveling of the vehicle 1, the control device 70 of the vehicle control system 10 calculates the unsprung displacement Zu in real time, based on the sensor-based information. Further, the control device 70 associates the wheel position and the unsprung displacement Zu at the same timing. Then, the control device 70 sends a set of the time-series data of the wheel position and the time-series data of the unsprung displacement Zu, to the map management system 100. The processor 120 of the map management system 100 generates and updates the unsprung displacement map 200 based on the time-series data of the wheel position and the time-series data of the unsprung displacement Zu.

As another example, the control device 70 of the vehicle control system 10 associates the wheel position and sensor-based information at the same timing. Then, the control device 70 sends a set of the time-series data of the wheel position and the time-series data of the sensor-based information, to the map management system 100. The processor 120 of the map management system 100 calculates the unsprung displacement Zu based on the received sensor-based information. Furthermore, the processor 120 generates and updates the unsprung displacement map 200 based on the time-series data of the wheel position and the time-series data of the unsprung displacement Zu.

In the case where the unsprung displacement Zu is calculated in the map management system 100, there is no constraint about processing time, and therefore, a filtering process can be performed using a zero-phase filter. By using the zero-phase filter, “phase shifting” can be prevented.

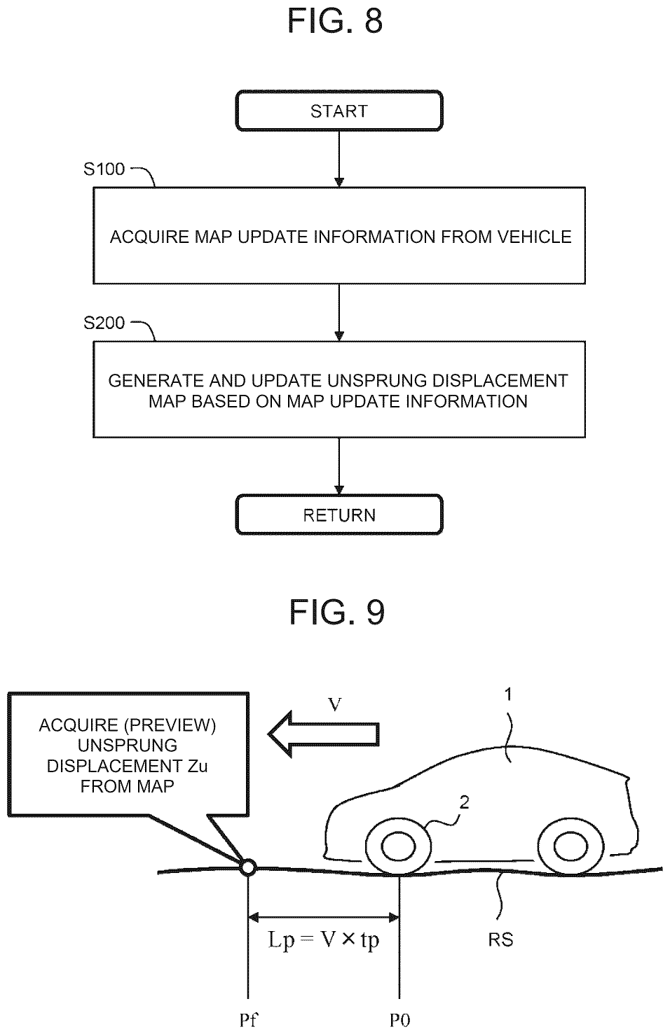

FIG. 8 is a flowchart schematically showing the map generation-update process according to the embodiment.

In step S100, the processor 120 of the map management system 100 acquires “map update information” from the vehicle 1 (vehicle control system 10) through the communication device 110. The map update information includes the time-series data of the position (wheel position) of the vehicle 1. Further, the map update information includes the time-series data of the sensor-based information (e.g.: the sprung displacement Zs and the stroke ST) that is necessary for calculating the unsprung displacement Zu. Alternatively, the map update information may include the time-series data of the unsprung displacement Zu calculated by the control device 70 of the vehicle control system 10.

In step S200, the processor 120 of the map management system 100 generates and updates the unsprung displacement map 200 based on the map update information.

### 3.4 Modification

The vehicle control system 10 of the vehicle 1 may hold a database for the unsprung displacement map 200, and may generate and update the unsprung displacement map 200 in the vehicle control system 10. That is, the map management system 100 may be included in the vehicle control system 10.

### 4 Preview Control Using Unsprung Displacement Map

The control device 70 of the vehicle control system 10 communicates with the map management system 100 through the communication device 50. The control device 70 acquires the unsprung displacement map 200 for an area including the current position of the vehicle 1, from the map management system 100. The unsprung displacement map 200 is stored in the storage device 72. Moreover, based on the unsprung displacement map 200, the control device 70 executes the “preview control”that is a kind of vibration damping control.

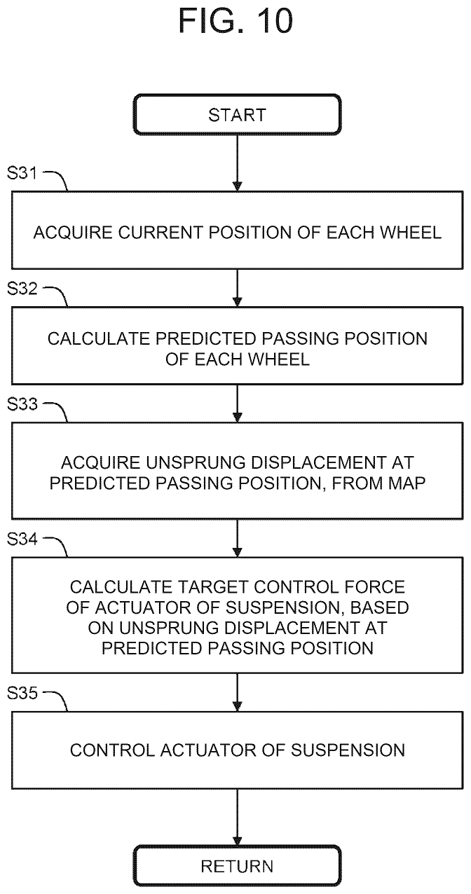

FIG. 9 is a conceptual diagram for describing the preview control. FIG. 10 is a flowchart showing the preview control. The preview control will be described with reference to FIG. 9 and FIG. 10.

In step S31, the control device 70 acquires a current position P0 of each wheel 2. The relative position relation between the reference point of the vehicle position in the vehicle 1 and each wheel 2 is known information. The position of each wheel 2 can be calculated based on the relative position relation and the vehicle position shown by the position information 94.

In step S32, the control device 70 calculates a predicted passing position Pf of the wheel 2 after a preview time tp. For example, the preview time tp is set so as to be more than or equal to a time required for a calculation process and a communication process that are necessary before the activation of the actuator 3A of the suspension 3. The preview time tp may be fixed, or may be varied depending on the situation. The preview distance Lp is given by the product of the preview time tp and the vehicle velocity V. The predicted passing position Pf is a position that is the preview distance Lp before the current position P0. As a modification, the control device 70 may calculate an expected traveling route based on the vehicle velocity V and the rudder angle of the wheel 2, and may calculate the predicted passing position Pf based on the expected traveling route.

In step S33, the control device 70 reads the unsprung displacement Zu at the predicted passing position Pf, from the unsprung displacement map 200.

In step S34, the control device 70 calculates a target control force Fc_t of the actuator 3A of the suspension 3, based on the unsprung displacement Zu at the predicted passing position Pf. For example, the target control force Fc_t is calculated as follows.

The motion equation about the sprung structure 5 (see FIG. 2) is expressed by the following expression (1).

$$\begin{matrix}Expression 1 & \\ m \cdot {Zs}^{″} = C ( {Zu}^{′} - {Zs}^{′} ) + K ( Zu - Zs ) - Fc & ( 1 )\end{matrix}$$

In the expression (1), m is the mass of the sprung structure 5, C is the attenuation coefficient of the damper 3D, K is the spring constant of the spring 3S, and Fc is the control force Fc in the vertical direction that is generated by the actuator 3A. In the case where the vibration of the sprung structure 5 is completely canceled by the control force Fc (Zs″=0, Zs′=0, Zs=0), the control force Fc is expressed by the following expression (2).

$$\begin{matrix}Expression 2 & \\ Fc = C \cdot {Zu}^{′} + K \cdot Zu & ( 2 )\end{matrix}$$

The control force Fc that causes at least the vibration damping effect is expressed by the following expression (3).

$$\begin{matrix}Expression 3 & \\ Fc = α \cdot C \cdot {Zu}^{′} + β \cdot K \cdot Zu & ( 3 )\end{matrix}$$

In the expression (3), a gain α is more than 0 and 1 or less, and a gain β is more than 0 and 1 or less. In the case where the derivative term in the expression (3) is omitted, the control force Fc that causes at least the vibration damping effect is expressed by the following expression (4).

$$\begin{matrix}Expression 4 & \\ Fc = β \cdot K \cdot Zu & ( 4 )\end{matrix}$$

The control device 70 calculates the target control force Fc_t in accordance with the expression (3) or the expression (4). That is, the control device 70 calculates the target control force Fc_t by substituting the unsprung displacement Zu at the predicted passing position Pf into the expression (3) or the expression (4).

In step S35, the control device 70 controls the actuator 3A such that the target control force Fc_t is generated at the timing when the wheel 2 passes through the predicted passing position Pf. The timing when the wheel 2 passes through the predicted passing position Pf is obtained from the preview time tp.

By the above-described preview control using the unsprung displacement map 200, it is possible to effectively restrain the vibration of the vehicle 1 (sprung structure 5).

### 5 Selection of Traveling Route

### 5.1 First Embodiment

The control device 70 of the vehicle control system 10 performs the autonomous driving control to control the autonomous driving of the vehicle 1. In the autonomous driving control, the control device 70 selects the traveling route of the vehicle 1, and controls the vehicle 1 such that the vehicle 1 travels along the selected traveling route. The traveling route is decided based on the current place of the vehicle 1, the destination, and the map information 91. The current place of the vehicle 1 is acquired from the position sensor 40. For example, the destination is acquired by accepting the input of the destination by the user, through the HMI 64. Alternatively, a waiting place for the vehicle 1 that is previously stored in the storage device 72 may be set as the destination, or the destination may be acquired through a wireless network, from a management server that manages the vehicle 1. When the destination is acquired, the control device 70 selects the traveling route from the current place of the vehicle 1 to the destination. Then, the control device 70 starts the autonomous driving of the vehicle 1 along the selected traveling route.

The preview control when the vehicle 1 travels on the traveling route will be discussed. In the preview control, the vehicle 1 is controlled based on the unsprung displacement Zu that is acquired from the map data about the unsprung displacement map 200. Accordingly, for executing the preview control, the unsprung displacement Zu needs to be enabled to be acquired from the map data about the unsprung displacement map 200. However, it is difficult to create the map data about all positions on the map. Accordingly, practically, there is a possibility that positions for each of which there is the map data and for each of which the preview control can be executed and positions for each of which there is no map data and for which the preview control cannot be executed exist in a mixed manner. When the traveling route of the vehicle 1 includes many positions for each of which there is no map data, the preview control cannot be executed during the traveling of the vehicle 1 on the traveling route, in many cases. As a result, there is a fear that the preview control cannot sufficiently improve the comfortableness of the vehicle 1.

However, the preview control is not always required at the time of the traveling of the vehicle 1. Specifically, the vehicle 1 sometimes performs the autonomous driving traveling in a state where no passenger rides. In such a case, there is a high possibility that the comfortableness of the vehicle 1 is not required. As examples of the case where no passenger rides, there can be the case of the traveling of the vehicle 1 toward a meeting place for the user, and the case of out-of-service traveling after the user is sent to a destination that is hoped by the user. In such cases, there is a low possibility that the comfortableness of the vehicle 1 is required, and rather, the acquisition of the map update information during the traveling is efficient for acquiring a larger amount of map update information for expanding the unsprung displacement map 200.

Hence, in the vehicle control system 10 in the first embodiment, at the time of the traveling in the state where no passenger rides in the vehicle 1, from routes from the current place of the vehicle 1 to the destination, a route for which the amount of the map data about the unsprung displacement map 200 is small is more preferentially selected than a route for which the amount of the map data is large, as the traveling route of the vehicle 1. That is, a route for which the amount of the map data is smaller is selected as the traveling route of the vehicle 1. Whether the amount of the map data for a certain route is smaller than that for another route can be evaluated from some standpoints described below.

### 5.2 Standpoints for Evaluating Whether Amount of Map Data for Certain Route is Smaller Than That for Another Route

In a first standpoint for evaluating whether the amount of the map data for a certain route is smaller than that for another route, the ratio of a section with the map data in the route is used. It can be said that the section with the map data is a section for which the unsprung displacement Zu (vertical motion parameter) can be acquired from the map data. In the first standpoint, the ratio (referred to as a “map existence ratio”, hereinafter) of the section with the map data is calculated for each route. Then, whether the amount of the map data for a certain route is smaller than that for another route can be evaluated by the mutual comparison of the map existence ratio. That is, the route for which the amount of the map data is smaller is a route for which the map existence ratio is lower. Whether the map data exists for a certain spot on the route may be determined based on whether the unsprung displacement Zu is associated with the position of at least one unit area M in the certain spot.

In the first standpoint, in the case where the unsprung displacement map 200 is constituted by a plurality of layers, the map existence ratio may be calculated for each of the layers. Then, whether the amount of the map data for a certain route is smaller than that for another route may be evaluated by the comparison of the total of the map existence ratios of the layers. On this occasion, the total of the map existence ratios of the layers may be a weighted sum that includes weights corresponding to the layers. For example, a case where the unsprung displacement map 200 is constituted by a plurality of layers stratified according to the number N of times of traveling will be discussed. In this case, the total of the map existence ratios may be calculated by such a weighted sum that a larger weight is given to a layer for which the number N of times of traveling is larger. Thereby, the map existence ratios can be compared in consideration of the number N of times of traveling also. That is, the route for which the amount of the map data is larger is a route for which the number N of times of traveling is larger and for which the map existence ratio about the map data is higher. The route for which the amount of the map data is smaller is the opposite of this. The route for which the amount of the map data is smaller is a route for which the map existence ratio is lower and for which the number N of times of traveling for the spot with the map is smaller.

In a second standpoint for evaluating whether the amount of the map data for a certain route is smaller than that for another route, the length of a section with the map data in the route is used. In the second standpoint, the length (referred to as a “map existence distance”, hereinafter) of the section with the map data is calculated for each route. Whether the amount of the map data for a certain route is smaller than that for another route can be evaluated by the mutual comparison of the map existence distance. That is, the route for which the amount of the map data is smaller is a route for which the map existence distance is shorter.

In the second standpoint also, in the case where the unsprung displacement map 200 is constituted by a plurality of layers, the map existence distance may be calculated for each of the layers. Then, whether the amount of the map data for a certain route is smaller than that for another route may be evaluated by the comparison of the total of the map existence distances of the layers. On this occasion, the total of the map existence distances of the layers may be a weighted sum that includes weights corresponding to the layers.

In a third standpoint for evaluating whether the amount of the map data for a certain route is smaller than that for another route, the number N of times of traveling per unit distance in the route is used. As the number N of times of traveling for a certain spot is larger, the amount of data constituting the map data for the certain spot is larger. Accordingly, it is thought that the amount of the map data for the route is larger as the number N of times of traveling per unit distance in the route is larger. In the third standpoint, the number N of times of traveling per unit distance is calculated for each route. Then, whether the amount of the map data for a certain route is smaller than that for another route can be evaluated by the mutual comparison of the number N of times of traveling per unit distance. That is, the route for which the amount of the map data is larger is a route for which the number N of times of traveling per unit distance is larger, and the route for which the amount of the map data is smaller is a route for which the number N of times of traveling per unit distance is smaller. In the calculation of the number N of times of traveling per unit distance, the number N of times of traveling for a certain spot on the route may be the average or total of the numbers N of times of traveling about unit areas M included in the certain spot. Alternatively, the maximum of the numbers N of times of traveling about unit areas M included in the certain spot may be adopted.

The above standpoints may be combined. For example, a case where the first standpoint and the third standpoint are combined will be discussed. In this case, the map existence ratio and the number N of times of traveling per unit distance are calculated for each route. Then, whether the amount of the map data for a certain route is smaller than that for another route is evaluated by the mutual comparison of the map existence ratio and the number N of times of traveling per unit distance. This comparison may be performed by calculating an evaluation value using the map existence ratio and the number N of times of traveling per unit distance as arguments. That is, the route for which the map data is smaller is a route for which the calculated evaluation value is lower. The configuration of the evaluation value may be appropriately determined depending on an environment in which the embodiment is applied. For example, the evaluation value is the linear sum of results from multiplying the map existence ratio and the number N of times of traveling per unit distance by coefficients respectively. Alternatively, as the mutual comparison of the map existence ratio and the number N of times of traveling per unit distance, the comparison of the map existence ratio and the comparison of the number N of times of traveling per unit distance may be performed in stages. For example, first, by the comparison of the map existence ratio, it is determined whether there is a gap of a predetermined value or more between one map existence ratio and the other map existence ratio. In the case where there is the gap of the predetermined value or more, a route for which the map existence ratio is lower is adopted as the route for which the amount of the map data is smaller. On the other hand, in the case there is no gap of the predetermined value or more, the comparison of the number N of times of traveling per unit distance is next performed. Then, a route for which the number N of times of traveling per unit distance is smaller is adopted as the route for which the amount of the map data is smaller.

From one of the above standpoints, the control device 70 of the vehicle control system 10 as an autonomous driving system evaluates whether the amount of the map data for a certain route is smaller than that for another route. Then, in the case where no passenger rides in the vehicle 1, the control device 70 more preferentially selects the route for which the amount of the map data is small than the route for which the amount of the map data is large, as the traveling route of the vehicle 1.

### 5.3 Processing Flow

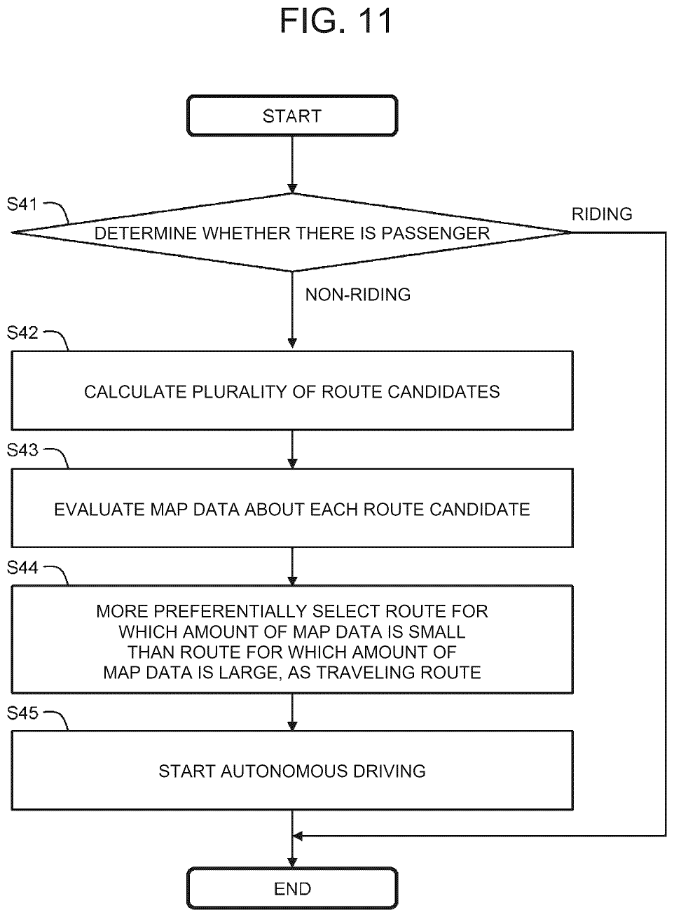

FIG. 11 is a flowchart showing an example of a processing flow that is executed by the control device 70 (more specifically, the processor 71), for the selection of the traveling route. The processing flow shown in FIG. 11 is started at a timing when the control device 70 acquires the destination and starts the autonomous driving.

First, in step S41, the control device 70 determines whether there is a passenger that rides in the vehicle 1. For example, whether there is a passenger can be determined by analyzing an image of an in-vehicle camera that picks up the interior of the vehicle 1. Alternatively, whether there is a passenger may be determined based on information from a load sensor installed at a seat of the vehicle 1. Alternatively, the control device 70 may determine that the passenger rides in the vehicle 1 in the case where some kind of operation by the passenger is input to the HMI 64, and may determine that no passenger rides in the vehicle 1 in the case where an instruction of the out-of-service traveling is acquired from the management server.

In the case where no passenger rides in the vehicle 1, the process proceeds to step S42. On the other hand, in the case where the passenger rides in the vehicle 1, the processing sequence ends. Even in the case where the passenger rides in the vehicle 1, the setting of the traveling route based on the current place and the destination is performed, and the autonomous driving of the vehicle 1 along the traveling route is performed. However, the description is omitted here.

In step S42, the control device 70 calculates a plurality of route candidates from the current place of the vehicle 1 to the destination. In the embodiment, the technique for calculating the route candidates is not particularly limited. For example, as the route candidates, all route candidates that allow the arrival at the destination without turning back are calculated.

Next, in step S43, the control device 70 evaluates the map data about each of the calculated route candidates. The content of the evaluation of the map data about each route candidate is determined depending on the standpoint that is employed from the above-described standpoints. For example, in the case where the first standpoint is employed, the map existence ratio of each route candidate is calculated by the evaluation of the map data. Further, for example, in the case where the second standpoint is employed, the map existence distance of each route candidate is calculated by the evaluation of the map data. Further, for example, in the case where the third standpoint is employed, the number N of times of traveling per unit distance of each route candidate is calculated by the evaluation of the map data. Further, for example, in the case where the combination of the first standpoint and the third standpoint is employed, the map existence ratio and the number N of times of traveling per unit distance are calculated for each route candidate, by the evaluation of the map data.

Next, in step S44, from the route candidates, the control device 70 more preferentially selects a route for which the amount of the map data is small than a route for which the amount of the map data is large, as the traveling route of the vehicle 1. Whether the amount of the map data for a certain route is smaller than that for another route is evaluated based on the evaluation result for the map data in step S43. For example, in the case where the first standpoint is employed, whether the amount of the map data is smaller is evaluated based on the map existence ratio. In this case, from the route candidates, the control device 70 more preferentially selects a route for which the map existence ratio is low than a route for which the map existence ratio is high, as the traveling route of the vehicle 1. Further, for example, in the case where the second standpoint is employed, whether the amount of the map data is smaller is evaluated based on the map existence distance. In this case, from the route candidates, the control device 70 more preferentially selects a route for which the map existence distance is short than a route for which the map existence distance is long, as the traveling route of the vehicle 1. Further, for example, in the case where the third standpoint is employed, whether the amount of the map data is smaller is evaluated based on the number N of times of traveling per unit distance. In this case, from the route candidates, the control device 70 more preferentially selects a route for which the number N of times of traveling per unit distance is small than a route for which the number N of times of traveling per unit distance is large, as the traveling route of the vehicle 1.

Typically, the traveling route that is selected in step S44 is a route candidate for which the amount of the map data is smallest among the route candidates. For example, in the case where the first standpoint is employed, the traveling route that is selected is typically a route candidate for which the map existence ratio is lowest. However, the more preferentially selecting, as the traveling route of the vehicle 1, the route for which the amount of the map data is small than the route for which the amount of the map data is large does not always need to be selecting, as the traveling route of the vehicle 1, the route for which the amount of the map data is smallest. That is, the selection of the traveling route of the vehicle 1 may be performed in consideration of an index different from the map data, as exemplified by the required time or the distance to the destination. For example, the control device 70 may be configured to consider the required time, and not to select a route candidate for which the required time is extremely long, as the traveling route of the vehicle 1, from the route candidates. In this case, when the required time of the route candidate for which the amount of the map data is smallest is extremely long, the route candidate for which the amount of the map data is smallest is not selected as the traveling route of the vehicle 1. The control device 70 more preferentially selects a route for which the amount of the map data is small than a route for which the amount of the map data is large, as the traveling route of the vehicle 1, from route candidates for each of which the required time is not extremely long.

Next, in step S45, the control device 70 starts the autonomous driving of the vehicle 1 along the selected traveling route. While the vehicle 1 travels by autonomous driving, the control device 70 acquires a value relevant to the vertical motion of the vehicle 1, from a sensor equipped in the vehicle 1. For example, the control device 70 acquires the sensor-based information for calculating the unsprung displacement Zu, from the vehicle state sensor 20. Alternatively, during the traveling of the vehicle 1, the control device 70 may acquire the value relevant to the vertical motion of the vehicle 1, from a camera that picks up a road surface. The acquired value is sent to the map management system 100 as the map update information, in sequence or after the end of the autonomous driving, and is used for the generation and update of the unsprung displacement map 200.

As described above, the control device 70 according to the embodiment selects the traveling route for the autonomous driving of the vehicle 1. As a modification, instead of calculating the route candidates, the control device 70 may previously read the unsprung displacement map 200, and may select the traveling route of the vehicle 1 such that the vehicle 1 more preferentially passes through a spot for which the amount of the map data is small than through a spot for which the amount of the map data is large. In this case, the control device 70 skips the processes in step S42 and step S43 shown in FIG. 11, and executes the process in step S44.

### 5.4 Specific Example

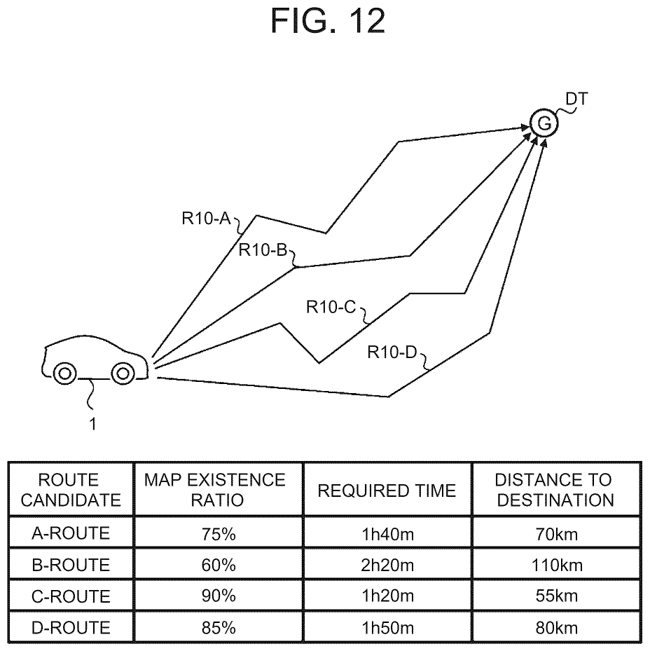

FIG. 12 is a conceptual diagram showing a specific example of the selection of the traveling route by the control device 70 of the vehicle control system 10. In the example shown in FIG. 12, the control device 70 calculates four route candidates R10 (an A-route R10-A, a B-route R10-B, a C-route R10-C, and a D-route R10-D) from the current place of the vehicle 1 to a destination DT. Furthermore, in the example shown in FIG. 12, the map existence ratios of the route candidates R10 are calculated. FIG. 12 shows an example in which whether the amount of the map data for a certain route is smaller than that for another route is evaluated based on the map existence ratio. Accordingly, the control device 70 more preferentially selects a route for which the map existence ratio is low than a route for which the map existence ratio is high, as the traveling route of the vehicle 1. Typically, the control device 70 selects the B-route R10-B for which the map existence ratio is lowest, as the traveling route of the vehicle 1. However, the control device 70 may exclude the B-route R10-B from selected objects for the traveling route of the vehicle 1, in consideration of the required time. In this case, for example, the control device 70 selects the A-route R10-A, as the traveling route of the vehicle 1.

### 5.5 Effect

In the first embodiment, when no occupant rides in the vehicle 1, the route for which the amount of the map data is small is more preferentially selected than the route for which the amount of the map data is large, as the traveling route of the vehicle 1. Further, during the autonomous driving traveling of the vehicle 1, the value relevant to the vertical motion of the vehicle 1 is acquired from the sensor in the vehicle 1, and the unsprung displacement map 200 is generated and updated based on the acquired value. Thereby, it is possible to acquire a large amount of vertical motion parameter at the spot for which the amount of the map data is small, and to efficiently expand the unsprung displacement map 200.

### 5.6 Second Embodiment

The first embodiment has been described above. Next, a second embodiment will be described. The second embodiment is an embodiment about the selection of the traveling route in the case where the occupant rides in the vehicle 1. As described above, when the traveling route of the vehicle 1 includes many positions for each of which there is no map data, the preview control cannot be executed during the traveling of the vehicle 1 on the traveling route, in many cases. As a result, there is a fear that the preview control cannot sufficiently improve the comfortableness of the vehicle 1.

Hence, in the second embodiment, in the case where the occupant rides in the vehicle 1, a traveling route of the vehicle 1 on which the preview control is likely to be executed is selected for improving the comfortableness of the vehicle 1.

In the case where the occupant rides in the vehicle 1, the control device 70 of the vehicle control system 10 according to the embodiment more preferentially selects, as the traveling route of the vehicle 1, a route for which the amount of the map data about the unsprung displacement map 200 is large, from routes from the current place of the vehicle 1 to the destination, than a route for which the amount of the map data is small. That is, a route for which the amount of the map data is larger is selected as the traveling route of the vehicle 1. Whether the amount of the map data for a certain route is larger than that for another route can be evaluated based on the same standpoints as those in the first embodiment.

### 5.7 Processing Flow

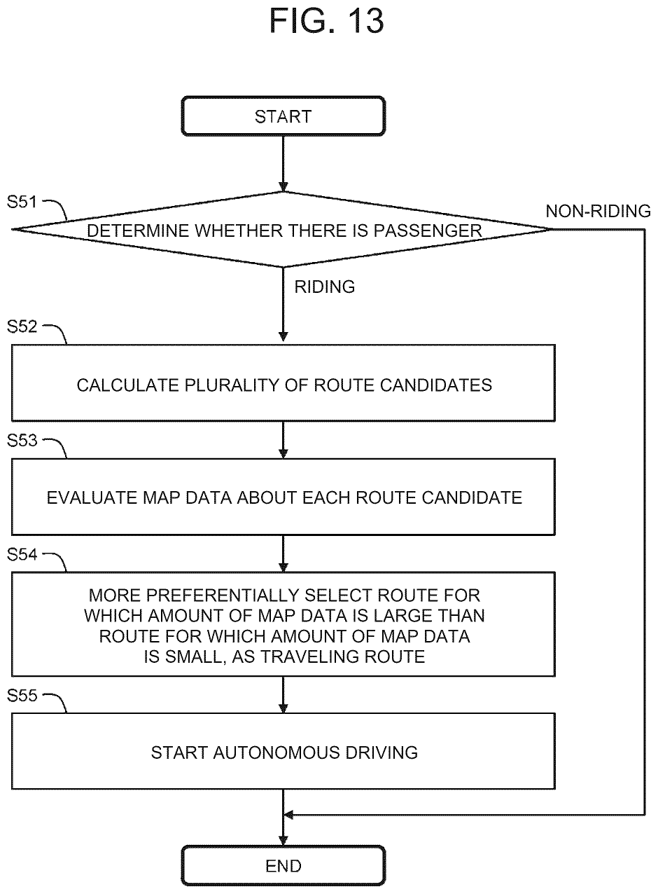

FIG. 13 is a flowchart showing an example of a processing flow that is executed by the control device 70 (more specifically, the processor 71), for the selection of the traveling route. The processing flow shown in FIG. 13 is started when the destination of the vehicle 1 is acquired and the autonomous driving is started.

In step S51, the control device 70 determines whether there is the passenger that rides in the vehicle 1. The method for determining whether there is the passenger is the same as that in step S41 of FIG. 11. In the case where the passenger rides in the vehicle 1, the process proceeds to step S52. In the case where no passenger rides in the vehicle 1, the processing sequence ends. Although the description is omitted here, an arbitrary method can be adopted as the method for selecting the traveling route in the case where no passenger rides in the vehicle 1.

Processes in step S52 and step S53 are the same as those in step S42 and step S43 of FIG. 11. The control device 70 calculates a plurality of route candidates from the current place of the vehicle 1 to the destination, and evaluates the map data about each of the calculated route candidates.

Next, in step S54, from the route candidates, the control device 70 more preferentially selects the route for which the amount of the map data is large than the route for which the amount of the map data is small, as the traveling route of the vehicle 1. Typically, the traveling route that is selected in step S54 is a route candidate for which the amount of the map data is largest among the route candidates. For example, in the case where the first standpoint is employed, the traveling route that is selected is typically a route candidate for which the map existence ratio is highest. However, the more preferentially selecting, as the traveling route of the vehicle 1, the route for which the amount of the map data is large than the route for which the amount of the map data is small does not always need to be selecting, as the traveling route of the vehicle 1, the route for which the amount of the map data is largest. That is, the selection of the traveling route of the vehicle 1 may be performed in consideration of an index different from the map data, as exemplified by the required time, the distance to the destination, or the fee. For example, the control device 70 may be configured to consider the required time, and not to select a route candidate for which the required time is extremely long, as the traveling route of the vehicle 1, from the route candidates.

Next, in step S55, the control device 70 starts the autonomous driving of the vehicle 1 along the selected traveling route. At this time, the control device 70 may present the selected traveling route to the user.

As described above, the control device 70 according to the embodiment executes the process about the selection of the traveling route of the vehicle 1. As a modification, instead of calculating the route candidates, the control device 70 may previously read the unsprung displacement map 200, and may select the traveling route of the vehicle 1 such that the vehicle 1 more preferentially passes through a spot for which the amount of the map data is large than through a spot for which the amount of the map data is small. In this case, the control device 70 skips the processes in step S52 and step S53 shown in FIG. 13, and executes the process in step S54.

### 5.8 Effect

With the second embodiment, in the case where the occupant rides in the vehicle 1, the route for which the amount of the map data is large is more preferentially selected than the route for which the amount of the map data is small, as the traveling route of the vehicle 1. Thereby, it is possible to select a route for which the amount of the map data is larger and for which the effectiveness of the preview control is high, as the traveling route of the vehicle 1. As a result, it is possible to improve the comfortableness of the vehicle 1.

### 5.9 Other Functions

In the second embodiment, as another function of the vehicle control system 10, a priority may be allowed to be set by the user of the vehicle 1. The control device 70 more preferentially selects the route for which the amount of the map data is large than the route for which the amount of the map data is small, as the traveling route of the vehicle 1. As described above, the control device 70 may consider an index different from the map data, in the selection of the traveling route of the vehicle 1. For example, the control device 70 may exclude a route for which the required time is extremely long, from selected objects for the traveling route of the vehicle 1, in consideration of the required time. Thereby, within a range in which the required time is not extremely long, a route for which the amount of the map data is larger is selected as the traveling route of the vehicle 1.

In some cases, the user hopes a route on which the comfortableness is higher, without minding the length of the required time. Hence, the control device 70 according to the embodiment may accept user's input for setting the priority about the use of the map data, at the time of the selection of the traveling route. Then, the control device 70 may select the traveling route of the vehicle 1, such that the degree of the consideration of an index different from the map data lowered as the priority set by the user is higher.

The user performs the setting input of the priority, through the HMI 64. The control device 70 acquires the priority set by the user, from the HMI 64. As an example of the setting input of the priority, the priority is set in stages. For example, the user sets the priority in three stages of level 1 to level 3. In this case, suppose that level 1 is the default and the priority becomes higher in the order of level 2 and level 3. In the example shown in FIG. 12, suppose that the control device 70 selects the A-route R10-A as the traveling route of the vehicle 1, when level 1 is set. At this time, for example, when the user sets the priority to level 3, the control device 70 lowers the degree of the consideration of the required time and the like, and selects the B-route R10-B as the traveling route of the vehicle 1.

As another example of the setting input of the priority, whether the map data is more preferentially used than each index is relatively set. For example, the user sets whether the map data is more preferentially used, for each of the required time, the distance to the destination, and the fee. Suppose that the required time is set as the default so as to be more preferentially used than the map data. At this time, in the example shown in FIG. 12, suppose that the control device 70 selects the A-route R10-A as the traveling route of the vehicle 1. For example, when the user sets the priority such that the map data is more preferentially used than the required time, the control device 70 lowers the degree of the consideration of the required time, and selects the B-route R10-B as the traveling route of the vehicle 1.

In this way, the setting of the priority about the use of the map data can be performed by the user, and thereby, the user can change the degree of the consideration of the index different from the map data. As a result, it is possible to improve the usability.

### 5.10 Selection of Traveling Route in Consideration of Traveling Lane

In the first embodiment and the second embodiment, for the traveling route, a designation of a lane on which the vehicle 1 travels may be included. A section that is on the selected traveling route of the vehicle 1 and for which there is the map data will be discussed. On this occasion, a position for which the amount of the map data is large and a position for which the amount of the map data is small sometimes exist in a mixed manner even in the section. For example, in the case where the section includes a plurality of lanes, there is the map data for a certain lane and there is not the map data for another lane, in some cases. That is, even when the vehicle 1 travels on a section for which there is the map data, there is a possibility that the vehicle 1 travels at a position for which there is no or little map data. In this case, the effectiveness of the preview control decreases, but the efficiency from standpoint of the expansion of the map data increases.

Therefore, for the traveling route of the vehicle 1, the designation of the lane on which the vehicle 1 travels may be included. In the first embodiment, in the case where no passenger rides in the vehicle 1, a lane for which there is no or little map data is preferentially selected. In the second embodiment, in the case where the passenger rides in the vehicle 1, a lane for which the amount of the map data is large is preferentially selected.

### 5.11 Update of Unsprung Displacement Map Due to Event

There is a possibility that an event that influences the vertical motion parameter occurs on the traveling route of the vehicle 1. Hereinafter, such an event is referred to as an objective event. Examples of the objective event include a construction that is performed on a road. In the case where a road construction has been performed, there is a possibility that the condition of the road surface is changed and the vertical motion parameter is different from that in the map data to be acquired from the unsprung displacement map 200 before the construction. Hence, in the first embodiment and the second embodiment, the control device 70 of the vehicle control system 10 may select the traveling route in consideration of a spot where the objective event has occurred. That is, in the first embodiment, in the case where no occupant rides in the vehicle 1, the control device 70 may preferentially select a route with a large number of spots where the event has been executed, as the traveling route of the vehicle 1. Further, in the second embodiment, in the case where the occupant rides in the vehicle 1, the control device 70 may preferentially select a route with a small number of spots where the event has been executed, as the traveling route of the vehicle 1. The control device 70 can acquire information about the objective event, that is, information about whether the objective event has been executed and information about the spot where the objective event has been executed, from the management server that manages the vehicle 1, for example.

The two embodiments about the selection of the traveling route of the vehicle 1 as the autonomous driving vehicle have been described above. The first embodiment and the second embodiment can be combined.

What is claimed is:

1. A control system including a sensor configured to acquire a value relevant to vertical motion of a wheel of a vehicle, the control system controlling an objective vehicle that performs autonomous driving, the control system comprising:
one or more processors; and
a storage device configured to store map data in which a vertical motion parameter relevant to the vertical motion is associated with a position on a map, wherein
the one or more processors are configured to:
determine whether a passenger rides in the objective vehicle,
more preferentially select a first route than a second route as a traveling route of the objective vehicle, in a case where the passenger does not ride in the objective vehicle, the map data of the first route being less than the map data of the second route, and
acquire the value relevant to the vertical motion from the sensor, while the objective vehicle is traveling.

2. The control system according to claim 1, wherein
the one or more processors are configured to more preferentially select the first route than the second route, and
in the first route, a ratio of sections from which the vertical motion parameter is enabled to be acquired from the map data is lower than in the second route.

3. The control system according to claim 1, wherein
the one or more processors are configured to more preferentially select the first route than the second route, and
in the first route, a length of sections from which the vertical motion parameter is enabled to be acquired from the map data is shorter than in the second route.

4. The control system according to claim 1, wherein
in the map data, a total number of times of traveling of vehicles that get involved in evaluation of the vertical motion parameter is associated with the position on the map,
the one or more processors are configured to more preferentially select the first route than the second route, and
in the first route, the total number of times of the traveling per unit distance is smaller than in the second route.

5. The control system according to claim 1, wherein
the first route and the second route include lanes designated for the objective vehicle to travel on,
the one or more processors are configured to more preferentially select the first route than the second route, and
in the first route, the map data for the lanes on which the objective vehicle travels is less than in the second route.

6. The control system according to claim 1, wherein
the one or more processors are configured to:
acquire information about spots where an event has been executed, the event influencing the vertical motion parameter, and
more preferentially select the first route than the second route, and
in the first route, a total number of the spots where the event has been executed is larger than in the second route.

7. The control system according to claim 1, wherein the one or more processors are configured to more preferentially select the second route than the first route, as the traveling route, in a case where the passenger rides in the objective vehicle.

8. A control system comprising:
a storage device configured to store map data in which a vertical motion parameter relevant to vertical motion of a wheel of a vehicle is associated with a position on a map; and
one or more processors configured to control an objective vehicle based on the vertical motion parameter to be acquired from the map data, wherein
the one or more processors are configured to:
determine whether a passenger rides in the objective vehicle, and
more preferentially select a first route than a second route as a traveling route of the objective vehicle, in a case where the passenger rides in the objective vehicle, the map data of the first route being more than the map data of the second route.
